(19) United States
(12) Patent Application Publication
(10) Pub. No.: US 2024/0161121 A1
(43) Pub. Date: May 16, 2024

(54) DETERMINING CUSTOMER HEALTH SCORES

(71) Applicant: SupportLogic, Inc., San Jose, CA (US)

(72) Inventors: Aditya Murthi, San Jose, CA (US); Balaji Ramachandran, San Jose, CA (US); Preetham Gopalaswamy, San Jose, CA (US); Anne Barry, San Jose, CA (US); Shuo Chen, San Jose, CA (US)

(21) Appl. No.: 18/498,366

(22) Filed: Oct. 31, 2023

Related U.S. Application Data
(60) Provisional application No. 63/424,205, filed on Nov. 10, 2022.

(51) Int. Cl. G06Q 30/015

(52) U.S. Cl. CPC G06Q 30/015

(57) ABSTRACT

A system derives training set factors for a customer sentiment score associated with a training set customer corresponding to training set support tickets, and a training set factor for a rate of a critical status corresponding to the training set support tickets. The system uses the training set factors to train a machine-learning model to determine a customer health score associated with the training set customer. The system derives factors for a customer sentiment score associated with a customer corresponding to support tickets, and a factor for a rate of a critical status corresponding to the support tickets. The trained machine-learning model uses the factors to determine a customer health score associated with the customer. The system enables a selection of escalating any customer account, de-escalating any customer account, escalating any support ticket, and/or de-escalating any support ticket, associated with the customer, in response to outputting the customer health score.

### CROSS REFERENCE TO RELATED APPLICATION

This application claims priority under 35 U.S.C. § 119 or the Paris Convention from U.S. Provisional Patent Application 63/424,205, filed Nov. 10, 2022, the entire contents of which is incorporated herein by reference as if set forth in full herein.

### BACKGROUND

Customer health is a metric that is used to measure the well-being of a customer's relationship with a client whose product and/or services are being used or consumed by the customer. In the technology industry, customer health may be an indicator of how engaged a customer is with a client's software product and how likely or unlikely the customer is to continue their partnership with the client. A customer health assessment typically involves using a system that evaluates both the quantitative and qualitative aspects of a customer's experiences with a client's product and/or services.

Ideally, such an evaluation system also tracks a customer's product and services needs and usage patterns and further provides recommendations for resolving issues quickly and efficiently, with the end goal of keeping the customer happy and ensuring business renewal opportunities in the future. To measure progress towards achieving such goals, an evaluation system needs to generate a customer health score that captures the health of a customer's relationship with a client at a given point in time. In terms of business objectives that a client is interested in furthering with a customer, typically the most important are minimizing customer account escalation and churn risk and maximizing the rate of renewal and the probability of upsell.

Customer satisfaction, as it relates to a software product or service, may be a direct measure of customer health, and might be defined as the difference between performance of a product or service that a customer utilizes and the customer's expectations and needs relative to the product or service. Therefore, a satisfied customer is mostly “happy” with a product or service, and therefore indicative of good customer health, while a dissatisfied customer is mostly “unhappy” with a product or service, and therefore indicative of poor customer health.

Currently, customer satisfaction and hence customer health is measured either directly by a client who uses customer health surveys and/or uses sales and revenue applications and product tracking data with the customer health surveys. Typically, these approaches measure customer satisfaction on a numeric scale, such as ranging from 0 to 10, or 1 to 7, but also use emoticons, thumbs-up, stars etc. Some of the most widely used industry metrics which are utilized to measure customer health/satisfaction are Net Promoter Score (NPS) and Customer Satisfaction Score (CSAT) because these metrics are rather straightforward in their implementation and are very easy to understand.

Net Promoter Score primarily measures how satisfied customers are with a client's product and how likely they are to recommend the product to another customer. This metric evaluates a customer's health or level of satisfaction based on a single question, which is, “How likely are you to recommend us to another customer?” Respondents are asked to answer on an 11-point scale with the following structure: scores from 0 to 6 indicate detractors who are likely to churn, scores from 7 to 8 indicate a passive customer, and scores from 9 to 10 indicate customers who are promoters of the client. The Net Promoter Score is then calculated as the difference between the percentage of customers who are promoters and the percentage of customers who are detractors, thereby resulting in a number between −100 and +100.

Customer Satisfaction Score is a Customer Experience (CX) metric that directly measures how satisfied a customer is with a product or service. A Customer Satisfaction Score survey asks customers a simple question “How satisfied are you with the product or service offered?” Customers usually rate their satisfaction with a client's product and/or services on a 5-star rating scale with 1 star indicating “Poor” and 5 stars indicating “Excellent.” The survey can also be configured to ask customers multiple questions which target certain specific aspects that the client wants to understand about the customer's overall satisfaction with the product. The final Customer Satisfaction Score is then calculated as the percentage of respondents with a 5-star rating relative to all respondents, which is then multiplied by 100, resulting in a score between 0 and 100.

While these two customer health metrics have many advantages in terms of their interpretability and relative ease with which they are calculated, these metrics suffer from some significant limitations. Extensive research on the Net Promoter Score has revealed that it is not straightforward to track whether a customer actually took action by promoting the client's brand even if the client selected a score that was relatively high. Furthermore, the Net Promoter Score does not directly reflect incremental improvements that a client makes to their product or services because of the peculiar bin designations used on their rating scale.

The Customer Satisfaction Score records only short-term sentiment in the sense that the score tends to express the customer's feelings on a particular day or instant of time. The Customer Satisfaction Score surveys are also subjective because people belonging to different demographics have different interpretations for what they mean by “dissatisfied” or “satisfied,” which could end up mis-representing “real” customer satisfaction. The Customer Satisfaction Score also suffers from low response rates due to customers not wanting to express their true feelings towards a product or a service, which also obfuscates interpretability.

### BRIEF DESCRIPTION OF THE DRAWINGS

FIG. 1 illustrates an example exponential decay graph that may be used for determining customer health scores, under an embodiment;

FIG. 2 illustrates a block diagram of an example system for determining customer health scores, under an embodiment;

FIG. 3 is a flowchart that illustrates a computer-implemented method for determining customer health scores, under an embodiment; and

FIG. 4 is a block diagram illustrating an example hardware device in which the subject matter may be implemented.

### DETAILED DESCRIPTION

Given the limitations with existing approaches to determining customer health metrics described above, determining an accurate customer health score takes a more comprehensive approach to measure overall customer experience by understanding the customer's journey through ingestion of large volumes of support ticket data from which underlying sentiment, efficacy and responsiveness of support agents and issues with a product or service may be accurately tracked over time. A ticketing system (such as Jira, GitHub, ServiceNow, Salesforce, Zendesk, and Freshdesk) generates tickets, which may be referred to as support tickets, service tickets, or cases, which track the interactions between individuals, users, groups, teams, and businesses in spaces such as support, user service, sales, engineering and information technology. Although many of the following examples are in the context of a ticketing system for a support space, embodiments of this disclosure apply equally to other ticketing systems for other spaces.

In an example, a user or a customer of a software product experiences a problem using the software product and uses a ticketing system to submit a support ticket to the company which provides services to support the software product. The support company employs a support agent to receive the support ticket and respond to the user or customer, to maintain strong accountability standards, and to command customer loyalty. In an ideal situation, the support agent accurately identifies, troubleshoots and resolves the customer's problem in a timely manner, and closes the support ticket, which increases the health of the customer. However, in a less than ideal situation, the customer may become dissatisfied with the response to the support ticket, relative to the urgency and/or importance of the problem, such as looming production failures, which decreases the health for the customer.

A modeling framework enables a client to obtain a more comprehensive and customer-centric health score, which may be used to pursue multiple objectives such as minimizing customer account escalation and churn risk and maximizing the rate of renewal and the probability of up sell. The modeling framework can ingest customer support ticket data, on behalf of a client, from various Customer Relationship Management (CRM) systems, such as Salesforce, Zendesk, etc. Data from support tickets, which may be referred to as cases, includes a detailed conversational log between a customer and a customer support agent intended to address product, Information Technology, and other technical issues that a customer is facing while using the client's product and/or service, in addition to including a plethora of case metadata. In order to get a comprehensive evaluation of customer health at any point in time, the modeling framework can use a multi-factor approach, basing the customer health score on deriving selected case factors such as customer sentiment, critical cases, complex cases, escalated cases, time to close cases, and the number of cases for a customer.

Embodiments herein determine customer health scores. A system derives training set factors for a customer sentiment score associated with a training set customer corresponding to training set support tickets, and a training set factor for a rate of a critical status corresponding to the training set support tickets. The system uses the training set factors to train a machine-learning model to determine a customer health score associated with the training set customer. The system derives factors for a customer sentiment score associated with a customer corresponding to support tickets, and a factor for a rate of a critical status corresponding to the support tickets. The trained machine-learning model uses the factors to determine a customer health score associated with the customer. The system enables a selection of escalating any customer account, de-escalating any customer account, escalating any support ticket, and/or de-escalating any support ticket, associated with the customer, in response to outputting the customer health score.

For example, a training modeling framework derived training set factors that indicated an increase in the rate of support tickets that had a critical status, including the most recent support ticket, for which the natural language processing drew inferences from the last comment by Chris, one the customer Acme Corporation's employees, as a frustrated response to the remote mount problem advice from Dana, one of the client's support agents, which implied that Chris following Dana's advice failed to correct Chris' problem. The training modeling framework used the training set factors to train a machine-learning model to calculate Acme's customer health score of 60, which included a customer sentiment sub-score of 25 for Chris' support ticket that Dana failed to help close. The training modeling framework continued training the machine-learning model to learn a confirmation of the low customer service score of 60, based on Mary, one of the client's customer support managers, responding to these scores by escalating the customer account for Acme, thereby committing to consuming additional resources on supporting the support tickets for Acme over a month.

After training, the modeling framework derives factors indicating a decrease in the rate of support tickets that have a critical status, including the most recent support ticket, for which the natural language processing draws inferences from the last comment by Ann, one the customer Acme's employees, as a thankful response to the advice from Bob, one of the client's support agents. The trained machine-learning model uses these factors to calculate Acme's newest customer health score of 80, which includes a customer sentiment sub-score of 95 for Ann's support ticket that Bob helped to quickly close. The system enables Sue, one of the client's customer support supervisors, to respond to these scores by de-escalating the customer account for Acme, thereby conserving the additional resources that would have been spent on supporting the support tickets for Acme over the next month.

Among the many factors that may be used to determine a customer health score, the factor “cstmr.sntmnt” is for the underlying customer sentiments that a customer implicitly expresses as signals while a customer support agent is handling. These signals are extracted, analyzed, and drawn inferences from by a modeling framework directly from the cases' conversational logs by using state-of-the science natural language processing and machine learning techniques. A customer may be an individual person or an organization that employs many individuals who communicate with support agents via cases. A machine-learning model can generate multiple customer sentiment sub-scores, such as a sub-score for each support ticket. A machine-learning model generates a weighted average sentiment score that expresses the customer's underlying sentiment across all support tickets that have been or are being worked on at any given point in time for a given customer account.

Clients typically want to compare how their customer support teams are performing across various business functions, such as business units, departments, and product groups. For this purpose, clients can use the customer sentiment scores and can specifically use how these scores evolve over time to ascertain performance of the customer support organization as a whole. These customer sentiment scores are computed directly from support tickets (which may be referred to as cases) based on over 40 different sentiment signals supported by the platform. In order to assess the performance of a group of support agents or a support team, these individual case-level scores are aggregated over a particular time interval such as a day, week, month or quarter and their evolution tracked over time. The platform can surface these score trends on an operational metrics webpage, thus enabling support executives to holistically analyze performance of their support teams.

The current methodology used to aggregate customer sentiment scores involves computing a simple average over a desired temporal interval, which creates relatively flat curves with very little variations in the customer sentiment scores, typically ranging between 68 and 70. This happens because of the underlying distributions of the customer sentiment scores that show large spikes at 70. Since the average scores are computed by accumulating the individual case scores for a given temporal period, such as daily, then computing the average, and since a large number of cases have sentiment scores around 70, this computation really tends to skew the average towards these “mean” numbers resulting in the lack of variability in the trends. This lack of variation in the customer sentiment score trends therefore do not help clients with their performance assessments as much as these scores could help the clients.

In order to address some of the limitations of the current score aggregation approach based on the simple average, an alternative method uses logic which suggests that the prior context of the case—whether the customer is already happy or unhappy—affects the score contributions from natural language processing of newly detected sentiments. If a customer sentiment score was high, such as more than 80 out of 100, and then the customer becomes frustrated or otherwise exhibits negative sentiment during a current event, the contribution of the newly detected negative sentiment will be greater than for a customer who has a neutral customer sentiment score or an already low customer sentiment score. The same is true when the system detects new positive sentiments for a customers who had a low customer sentiment score. In both situations, the newly detected customer sentiment results in a score contribution that is weighted 150% of a normal weight, so that if the customer sentiment score is already very high, then a new negative customer sentiment that would have contributed a value of −5 to a new customer sentiment score contributes a value of −7.5 instead to the new customer sentiment score.

This provides additional ‘punishment’ for cases in which a support agent manages to annoy or frustrate a customer who is already happy, and provides an additional reward for cases in which a support agent manages to make an unhappy customer much happier. The same process occurs for sentiments which occur in the same direction as the existing customer sentiment score, such that new positive contributions are lessened when the customer already has a high sentiment score, and new negative contributions are lessened when the customer already has a low customer sentiment score. The baseline multiplier for this effect is 50% (multiplied by 0.5) but if the existing customer sentiment score is very close to 100 or 0, the multiplier will decrease to 25% (multiplied by 0.25). If the customer sentiment score still exceeds the range of 0 to 100, the system caps the customer sentiment score to the most extreme allowable value.

Another alternative method weighs individual sentiment scores by their distribution probabilities of occurring while computing a weighted average to address some of the limitations of the current score aggregation approach based on the simple average. The weights are computed by inverting the probabilities associated with each score bin of the sentiment score distributions and then applying a non-linear transformation to these inverted probabilities. In this way, cases with scores at the tails of the aforementioned distributions get larger weights while those with scores close to 70 get weights that are close to zero. Therefore, even if for a given day, a sizable fraction of the cases have sentiment scores close to 70, the effect of these scores on the resulting average is diminished. The weighted average scores show more variability as compared with those computed using the simple average. The weights are computed by inverting the score bin probabilities and then applying a non-linear transformation to the resulting numbers. Therefore, depending on how much score variation is desired, there are a number of such non-linear transformation functions that may be applied to address specific business needs or outcomes.

The weights used to compute the weighted average score for customer sentiment may be determined directly from the sentiment score distribution by inverting the raw probabilities associated with consecutive sentiment score bins, which is done so that very low/high case sentiment scores have a greater impact on the customer account health score. In a simplified example, a normal distribution with a mean of 70 and a standard deviation of 10 would have 99.7% of its value within 3 standard deviations of the mean, which would be from 40 to 100. The probability of the sentiment score being from 70 to 80 would be 34.1%, such that any sentiment score in this range, such as 77, would be multiplied by the weight determined by the inverse of 0.341, which is 1/0.341=2.93, when a weighted average of the sentiment score is calculated. Likewise, any sentiment score from 60 to 70, such as 64, would also be multiplied by the weight of 2.93.

The probability of the sentiment score being from 80 to 90 would be 13.6%, such that any sentiment score in this range, such as 89, would be multiplied by the weight determined by the inverse of 0.136, which is 1/0.136=7.35, when a weighted average of the sentiment score is calculated. Likewise, any sentiment score from 50 to 60, such as 55, would also be multiplied by the weight of 7.35. The probability of the sentiment score being from 90 to 100 would be 2.1%, such that any sentiment score in this range, such as 91, would be multiplied by the weight determined by the inverse of 0.021, which is 1/0.021=47.62, when a weighted average of the sentiment score is calculated. Likewise, any sentiment score from 40 to 50, such as 47, would also be multiplied by the weight of 47.62.

Among the many other factors that may be used to determine a customer health score, the factor “case.crtcl” is for a critical status case or a severe business impact status case which may be expressed as statuses of criticality or severity, such as severity=0 for non-critical cases, severity=1 for critical cases, and severity=2 for extremely critical cases. Critical cases with such “severity” status flags are typically high priority due to their business impact and therefore are required to be addressed as soon as possible. Consequently, from a customer support health perspective, having a large number of such critical or severe status cases at any point in time significantly impacts a customer's business operations and is detrimental to the overall customer support health.

Among the many additional factors that may be used to determine a customer health score, the factor “case.cmplx” is a status for a case which requires complex engineering intervention and therefore is an indirect measure of the case's resolution complexity and time. Having a large number of such complex status cases at any time requires more time to resolve and close and is consequently detrimental to the overall customer support health.

Also among the many factors that may be used to determine a customer health score, the factor “case.esclt” is a status for a case which was escalated to a higher level of customer support by the customer and/or the agent working on the case, either due to the impact the case had on operations or due to a request from a customer whose usage of a product or service might be impeded. The number of escalated status cases at any time requires more resources to support and therefore is detrimental to the overall customer support health.

Among the many factors that may be used to determine a customer health score, the factor “case.clsd” is for the time required to close or resolve a case, which is tracked by case age, and may indicate the average or median case closure or resolution time, typically measured in days. To provide a measure of the customer support agents' efficacy at resolving cases, the machine-learning model first calculates the case ages or closure times as the difference between case closure dates or the current date (if a case is still active) and the creation dates for all cases created by a customer account. Then the machine-learning model computes the median or average case ages for cases created or closed within the last n days, case.clsdₙ(t) as well as cases closed for the lifetime of a customer account case.clsd_{g}(t). The machine-learning model compares these two metrics against each other and measures how fast cases are being addressed and closed by agents. For example, if at any given point in time case.clsd₉₀>case.clsdₙ, then the comparison indicates that currently (during a recent 90-day period), agents are taking more time on average to close out cases compared to how much time they have spent closing out cases historically. This indication might provide insights, for instance, not only into whether customer agents have the right combination of skills and experience to address issues, but also into the complexity of the products being resolved and the user experience as a whole.

As the most basic factor that may be used to determine a customer health score, the factor “case.nmbr” is for the total number of cases, which is a customer engagement trend measured by the volume of cases filed on a daily/weekly/monthly basis and how these change over time. The total number of cases may be used to normalize the other factors and therefore serve as score contribution bounds, such as when the number of escalated cases is 10, and is divided by the total number of all cases, which is 100, to determine the rate of escalated cases is 10%. Additionally, a product's group or functional unit to which a case belongs, the number of agents working on a case, and the time between successive exchanges between agent and customer could be factors used to determine a customer health score.

The customer support health model constitutes a simple accounting framework that keeps track of any cases that were created, closed or are open/active at any given point in time. For simplicity, these three categories for cases may be referred to as “channels.” From a customer support perspective, case creation and open cases are taken to negatively impact the customer health score, while case closure has a positive impact on the customer health score. The first part of the modeling process involves building and running a query that generates any of the various factors per channel→{new, closed, open}per customer account for any time period.

The modeling framework derives factors at daily temporal resolution because a large majority of customer accounts only generate a case or two every few days, and therefore there is too much data sparsity at sub-daily time-intervals, and because the customer health score is not expected to vary too much within a day. For each of the above factors, the machine-learning model computes an absolute component, which uses raw total counts, and a trend component, which reflects changes in total counts, both of which can impact the final customer health score in positive and negative ways, depending on the creation of cases, the closure of cases, and the open case trends over time. In order to enable this, the machine-learning model introduces a set of impact factors impct^{ablst} (chnnl,fctr), impct^{trnd}(chnnl,fctr), and weights wght(chnnl,fctr) that determine the overall impact each of these factors have on the customer health score at any time. The machine-learning model sums these individual factor score contributions linearly to produce the customer health score of a customer account for any given time instant.

A set of total number-based factors may be defined as fctr(accnt,chnnl,tm)={case.nmbr, case.crtcl, case.esclt, case.cmplx}(accnt,chnnl,tm), which are produced by the factor generation process described for an account, channel, and time. The total number of cases may be defined at any point in time as case.nmbr(accnt,tm), case.nmbr(chnnl=clsd,tm)+case.nmbr(chnnl=opn,tm)+case.nmbr(chnnl=nw,tm)

and its local trend as δcase.nmbrₜₜₗ(accnt,tm)=[(case.nmbrₜₜₗ(accnt,tm)−case.nmbrₜₜₗ(accnt,tm−1)]/case.nmbrₜₜₗ(accnt,tm−1)

These two quantities may be used to normalize the factors and therefore serve as score contribution bounds when the raw total counts and their trends are multiplied by their corresponding impact factors impct(chnnl,fctr). For each factor in the set fctr defined above, the absolute and trend components may be defined as:

fctr^{abslt}(accnt,chnnl,tm)=[fctr(accnt,chnnl,tm)/case.nmbr(accnt,tm)]*impct^{abslt}(chnnl,fctr)*wght(chnnl,fctr) EQUA. 1)

fctr^{trnd}(accnt,chnnl,tm)=[[fctr(accnt,chnnl,tm)−fctr(accnt,chnnl,tm−1)]/fctr(accnt,chnnl,tm−1)]*(1/δcase.nmbrₜₜₗ(accnt,tm)*impct^{trnd}(chnnl,fctr)*wght(chnnl,fctr) (EQUA. 2)

Therefore, the total contribution to the customer health score from any factor is:

fctr(accnt,chnnl,tm)=Σ_{chnnl}(fctr^{abslt}(accnt,chnnl,tm)+fctr^{trnd}(accnt,chnnl,tm)) (EQUA. 3)

Note here that for the first time period, time=0. δcase.nmbrₜₜₗ(accnt,tm) is not defined, and hence fctr^{trnd}(accnt,chnnl,tm) is set to a value of zero. For the weighted average sentiment score, cstmr.sntmnt(accnt,tm) at time=0 may be defined as (cstmr.sntmnt(accnt,tm)=[[cstmr.sntmnt(accnt,tm)−70]/70]*impct^{sntmnt}*wght^{sntmnt}

For all other time periods the machine-learning model only tracks how the weighted average sentiment score changes over time. That is:

cstmr.sntmnt(accnt,tm),[[cstmr.sntmnt(accnt,tm)−cstmr.sntmnt(accnt,tm−1)]/cstmr.sntmnt(accnt,tm−1)]/*[1/δcase.nmbrₜₜₗ(accnt,tm)]*impct^{sntmnt}*wght.^{sntmnt} (EQUA. 4)

Similarly for the median case age factor, case.clsdₙ(t), the machine-learning model once again has two components in:

case.clsd^{abslt}(accnt,tm)=[[case.clsd₉₀(accnt,tm)−case.clsd_{g}(accnt,tm)]/case.clsd_{g}(accnt,tm)]*impct^{case.clsd}*wght^{case.clsd} (EQUA. 5)

and:

case.clsd^{trnd}(accnt,tm)=[[case.clsd₉₀(accnt,tm)−case.clsd₉₀(accnt,tm−1)]/case.clsd₉₀(accnt,tm−1)]*[1/δcase.nmbrₜₜₗ(accnt,tm)]*impct^{case.clsd}*wght^{case.clsd} (EQUA. 6)

Once again, note that for time=0, case.clsd^{trnd} (accnt,tm)=0. case.clsd(accnt,tm) is defined as case.clsd^{absdlt}(accnt,tm)+case.clsd^{trnd}(accnt,tm) as the total contribution from case age. The customer health score, ahs(accnt,tm) is then given by:

ahs(accnt,tm)=scoreᵢₙₜₗ+Σ_{fctr} fctr(accnt,tm)+cstmr.sntmnt(accnt,tm)+case.clsd(accnt,tm) (EQUA. 7)

Where scoreᵢₙₜₗ is a baseline score that is configurable and may be set as per customer requirements. Notice that the customer health score defined in equation (7) above for a given customer account is essentially a point in time estimate. This means that the machine-learning model computes the score only using factor information corresponding to the current and previous time periods.

However, intuition suggests that the health of a customer account should not only depend on the current state of its factors, but also on how these factors have evolved over time. Therefore, in order to incorporate this temporal dependence, the machine-learning model can also introduce an exponential weighting function that basically generates temporal weights, h(t), for the past n days based on an exponent parameter that controls how much “emphasis” the machine-learning model places on more recent case activity as opposed to past activity. The machine-learning model applies these weights to past n historical customer health scores, including the current score that is computed for the current time period t using equation (7), to produce an exponentially weighted average score, ahs(accnt,tm) at time period t:

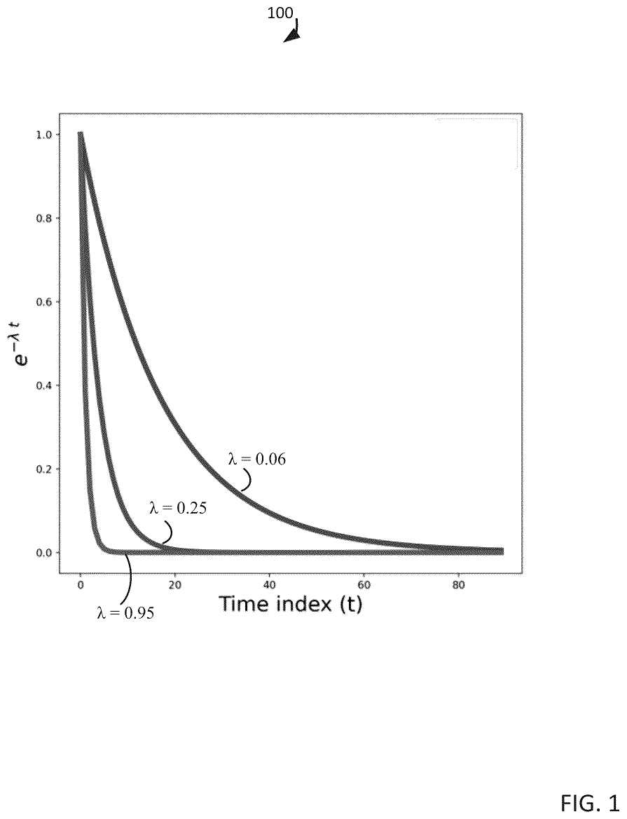

ahs(accnt,tm)=Σₚ₌ₜᵢₘₑ^{time-n} h(p)*ahs(accnt,tm)/Σₚ₌ₜᵢₘₑ^{time-n} h(p) (EQUA. 8)
where h(p)=e^{(-λ*p)}; p=time, time−1, time−2, . . . time−n are the exponential weights, λ is the exponent parameter that controls how much emphasis is placed on more recent customer account activity compared to past activity. Based on the definition above, h(p) decreases exponentially from a value of 1 at time t to a value of 0 at p=time—n, depending on the value of λ. This is clearly seen in FIG. 1, wherein h(p) is plotted against a time index for different values of λ. Over a 90-day period, the value decreases gradually until becoming close to 0 around 80 days for λ=0.06, decreases until becoming close to 0 around 20 days for λ=0.25, and decreases steeply until becoming close to 0 after a few days for λ=0.95. Each client can select an exponential weight/parameter that reflects the client's experiences regarding how long their customers tend to retain the sentiment and memory of recent activities.

The customer health score calculated using equation (8) produces a number on a scale between 0 and 100. Scores on the lower end of this scale which are closer to 0 indicate “Bad” customer health, while those scores which are closer to 100 indicate “Good” customer health. The customer support score offering on its user interface surfaces both a numeric value as well as a label (“Bad”, “Fair” or “Good”) that clients can use to take a number of actions related to the customer account depending on their specific use case. Some examples of such use cases are to make decisions on whether to escalate or de-escalate a customer account or a customer support ticket, to assess whether a customer account is going to churn, to assess the overall customer health that can provide insights into customer account renewal or up-sell opportunities, and the identification of negative trends in customer interactions over time via sentiment score trends and proactively identify a wellness path moving forward.

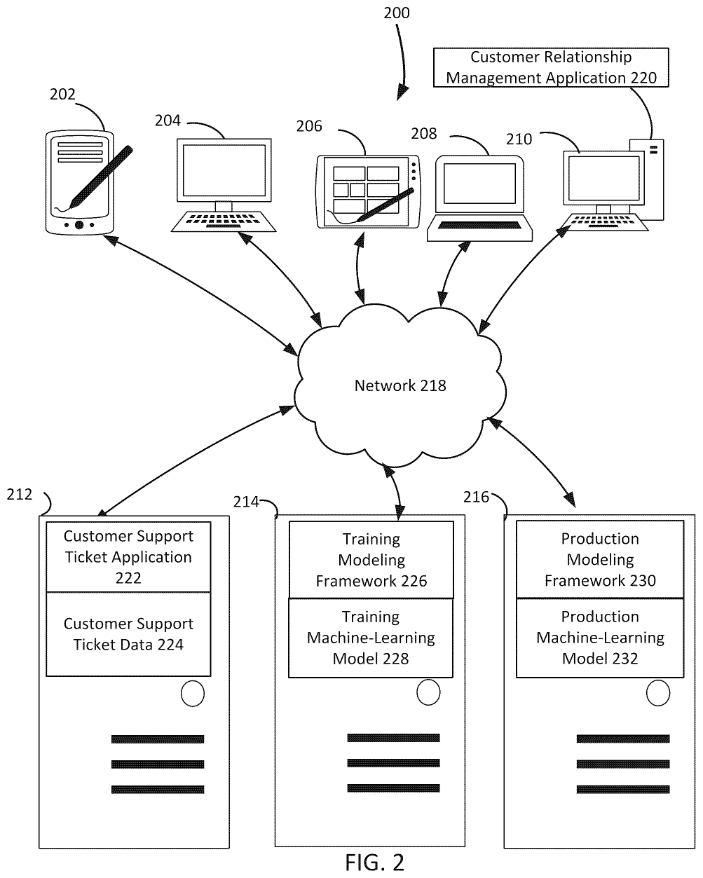

FIG. 2 illustrates a block diagram of an example system 200 for determining customer health scores, under an embodiment. As shown in FIG. 2, the system 200 may illustrate a cloud computing environment in which data, applications, services, and other resources are stored and delivered through shared data centers and appear as a single point of access for the users. The system 200 may also represent any other type of distributed computer network environment in which servers control the storage and distribution of resources and services for different client users.

In an embodiment, the system 200 represents a cloud computing system that includes a first client 202, a second client 204, a third client 206, a fourth client 208, a fifth client 210; and a first server 212, a second server 214, and a third server 216 that may be provided by a hosting company. The clients 202-210 and the servers 212-216 communicate via a network 218. The first server 212 may be referred to as the customer support server 212, the second server 214 may be referred to as the training server 214, and the third server 216 may be referred to as the production server 216.

As depicted by FIG. 2, the fifth client 210 may include a customer relationship management application 220, although each of the clients 202-210 may include a copy of the customer relationship management application 220 and/or other types of applications. The customer support server 212, may include a customer support ticket application 222, which may include customer support ticket system 224. The training server 214 may include a training modeling framework 226, which may include a training machine-learning model 228, and the production server 216 may include a production modeling framework 230, which may include a production machine-learning model 232. The machine-learning models 228 and 232 may be based on any of a variety of models, such as gradient boosted classifiers, k-nearest neighbor classifiers, neural networks, random forests, support vector machines, naive Bayes classifiers, and logistic regression models.

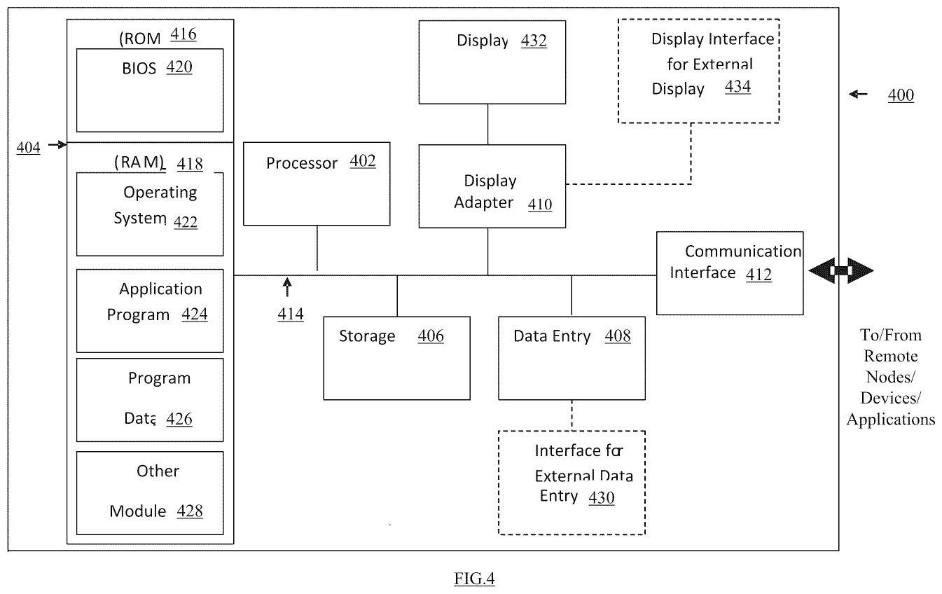

Even though FIG. 2 depicts the first client 202 as a smartphone 202, the second client 204 as a terminal 204, the third client 206 as a tablet computer 206, the fourth client 208 as a laptop computer 208, the fifth client 210 as a personal computer 210, and the servers 212-216 as servers 212-216, each of the system components 202-216 may be any type of computer system. The system elements 202-216 may each be substantially similar to the hardware device 400 depicted in FIG. 4 and described below. While FIG. 2 depicts the system 200 with five clients 202-210, three servers 212-216, one network 218, two applications 220 and 222, one type of data 224, two modeling frameworks 226 and 230, and two machine-learning models 228 and 232, the system 200 may include any number of clients 202-210, any number of servers 212-216, any number of networks 218, any number of applications 220 and 222, any number of types of data 224, any number of modeling frameworks 226 and 230, and any number of machine-learning models 228 and 232.

Although FIG. 2 depicts all of the training elements 226 and 228 residing completely on the training server 214, any or all of the training elements 226 and 228 may reside completely on the production server 216, or in any combination of partially on the training server 214, partially on the production server 216, and partially on the clients 202-210, such as by residing as data management applications on the clients 202-210, and partially on another server which is not depicted in FIG. 2. While FIG. 2 depicts all of the production elements 230 and 232 residing completely on the production server 216, any or all of the production elements 230 and 232 may reside completely on the training server 214, or in any combination of partially on the production server 216, partially on the training server 214, partially on the clients 202-10, such as by residing as data management applications on the clients 202-210, and partially on another server which is not depicted in FIG. 2. After training to determine customer health scores, the system 200 may be referred to as the trained system 200.

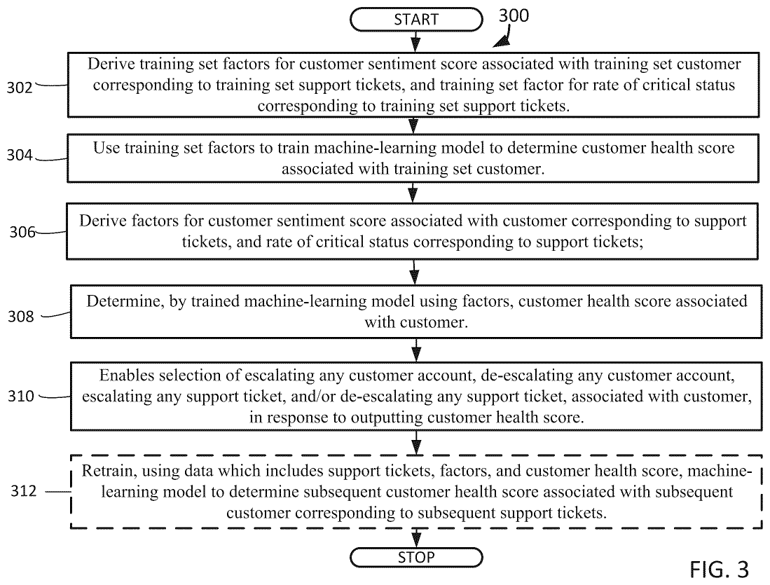

FIG. 3 is a flowchart that illustrates a computer-implemented method for determining customer health scores, under an embodiment. Flowchart 300 depicts method acts illustrated as flowchart blocks for certain actions involved in and/or between the system elements 202-232 of FIG. 2.

Training set factors are derived for a customer sentiment score associated with a training set customer corresponding to training set support tickets, and a training set factor is also derived for a rate of a critical status corresponding to the training set support tickets, block 302. The system derives training set factors, to determine a customer health score, from training set support tickets. For example, and without limitation, this can include the training modeling framework 226 deriving training set factors indicating an increase in the rate of support tickets that have a critical status, including the most recent support ticket, for which the natural language processing draws inferences from the last comment by Chris, one the customer Acme Corporation's employees, as a frustrated response to the remote mount problem advice from Dana, one of the client's support agents, which implies that Chris following Dana's advice failed to correct Chris' problem.

A training set factor can be an influence that previously contributed to a result and is used as an example for learning. A customer sentiment score can be a metric for a feeling or an attitude by a product or service user towards a situation. A training set customer can be a person or organization that utilized an item that was sold or leased and who is used as an example for learning.

A training set support ticket can be a request that had been logged onto a work tracking system, detailing an issue that needed to be addressed, and that is used as an example for learning. A rate can be a quantity measured against some other quantity. A critical status can be a classification of a support ticket as having a severe impact.

A customer's sentiment may be challenging to determine because such an evaluation is so heavily dependent on human nature. Since every person is unique, each employee of a customer may have a different tolerance for a delayed resolution of a support ticket and a different appreciation for accelerated resolution for a support ticket. Furthermore, each employee's sentiment varies based on a wide variety of subtle factors. Some of these factors are more quantifiable, including the recent history of the employee's problems, the recent history of the employee's support ticket interactions, and the employee's perception of the ‘appropriate’ resolution time for a support ticket. The modeling frameworks 226 and/or 230 can directly derive these factors from the support tickets, and from the record of historical interactions.

Emotional factors are more difficult to quantify, including the impact on an employee's work or their business, whether the employee is upset because the employee was away or on vacation when a problem occurred and still had to respond to the problem, how visible the problem is to the employee's supervisor, and the employee's stress level. Since these factors are more difficult to capture, the modeling frameworks 226 and/or 230 can use proxies to incorporate the effect of these behavioral components. For example, the modeling frameworks 226 and/or 230 can use natural language processing to extract indications of a customer employee's impatience, frustration, sense of building urgency, and/or references to production issues from the employee's support ticket comments. The machine-learning models 228 and/or 232 can identify key expressions that may provide insight into the sentiment of a customer. For example, the machine-learning models 228 and/or 232 can calculate a customer sentiment score based on applying natural language processing to the support ticket interactions to identify a lack of progress with the major problem of a support ticket, such as customer comments indicating that the suggested solutions “did not work,” or “were not helpful.”

In addition to using a natural language processor to draw inferences from the content of a support ticket's messages between a customer and a support agent, the machine learning models 228 and/or 232 can analyze the support ticket's metadata to correctly identify any sentiment. For example, if the customer support agent replies, “sorry for the delayed reply,” but only a few minutes have elapsed since the customer's message was received, the machine learning models 228 and/or 232 can draw the inference that this response is an indication of excessive politeness and an apologetic tone, and may result in inferring a positive sentiment for the customer. As a counterexample, if the customer support agent did not reply promptly to a customer's message and did not apologize for a delayed response, then the machine-learning model 226 and/or 232 may determine whether the customer's message conveyed the need for the customer support agent to respond soon. While the customer support agent's delayed response combined with the lack of the customer support agent's apology does not necessarily directly indicate the sentiment of a customer, the machine-learning model 226 and/or 232 can learn that a 4-hour response time for a minor issue is likely to be acceptable for the customer, whereas such a delayed response would clearly not be tolerable for the customer during a widespread production outage, and therefore could infer a negative sentiment for the customer due to the perception of a poor customer experience.

The training set factors optionally include a rate of a complex status corresponding to the training set support tickets, a rate of an escalation status corresponding to the training set support tickets, an average resolution time corresponding to the training set support tickets, and/or a total count of the training set support tickets. For example, the training modeling framework 226 derived training set factors indicating an increase in the rate of Acme's support tickets that have a complex status and an increase in the rate of Acme's support tickets that have an escalation status, including the most recent support ticket which was a complex support ticket that was escalated by Chris, one of the Acme customer's employees. For this example, the training modeling framework 226 also derived training set factors indicating that during the most recent 90-day period, support agents were taking more time on average to close out Acme's cases compared to how much time they have spent closing out Acme's cases historically, and that Acme had a total of 100 support tickets that were either created, closed, or open during the last month, which is a significantly more than the average total number of these types of support tickets for Acme during a typical one-month period.

A complex status can be a classification of a support ticket as having a complicated resolution. An escalation status can be a classification of a support ticket as having increased support for resolution. An average resolution time can be a mean of the chronological periods required to close support tickets. A total count can be a whole or complete amount or number of something.

Each of the training set factors can correspond to a value associated with a time in one of the training set support tickets and can correspond to a change in values associated with a current time and a preceding time in the one of the training set support tickets. For example, the training machine-learning model 228 computes an absolute count of 10 Acme support tickets that were escalated, and a trend which is an increase by 2.5% in the rate of escalated Acme support tickets based on the previous rate of 7.5% escalated support tickets (6 of the 80 Acme support tickets had been escalated) and the current rate of 10% escalated support tickets (10 of the 100 Acme support tickets have been escalated).

A value can be a numerical amount, magnitude, or quantity. A time can be a digital record of the chronology of occurrence of a particular event. A change can be a modification. A current time can be the present chronological space. A preceding time can be the most recent chronological space.

After deriving the training set factors for determining a training set customer's customer health score, the training set factors are used to train a machine-learning model to determine a customer health score associated with the training set customer, block 304. The system trains a training machine-learning model to use training set factors to determine a customer health score. By way of example and without limitation, this can include the training modeling framework 226 using the training set factors to train the training machine-learning model 228 to calculate Acme's customer health score of 60, which includes a customer sentiment sub-score of 25 for Chris' support ticket that Dana failed to help close. The training modeling framework 226 continues training the training machine-learning model 228 to learn a confirmation of the low customer health score of 60, based on Mary, one of the client's customer support managers, responding to these scores by escalating the customer account for Acme, thereby committing to consuming additional resources on supporting the customer support tickets for Acme during a subsequent month.

A machine-learning model can be an application of artificial intelligence to dynamic data that provides a system with the ability to automatically learn and improve from experience without being explicitly programmed. A customer health score can be a metric that measures the well-being of a relationship between a person or organization utilizing a product and/or a service and a client who is providing the product and/or the service.

Following the training of a machine-learning model to determine customer health scores, factors are derived for a customer sentiment score associated with a customer corresponding to support tickets, and a factor is also derived for a rate of a critical status corresponding to the support tickets, block 306. The system derives factors, to determine a customer health score, from support tickets. In embodiments, this can include the production modeling framework 230 deriving factors indicating a decrease in the rate of support tickets that have a critical status, including the most recent support ticket, from which the natural language processing draws inferences from the last comment by Ann, one the customer Acme Corporation's employees, as a thankful response to the advice from Bob, one of the client's support agents. A factor can be an influence that contributes to a result.

Deriving any factors for the customer sentiment score optionally includes using natural language processing and machine learning techniques to extract, analyze, and draw inferences from signals from conversational logs in support tickets corresponding to the customer when an event occurs for any of the corresponding support tickets and at a specified frequency for any of the corresponding support tickets. For example, the machine-learning models 228 and/or 232 may be queried both when a new event occurs for a support ticket, such as when a customer's employee generates a new comment, and/or at a specified frequency, such as every 4 hours, as time dependent factors may cause the customer employee's sentiment to change even when there is no support ticket activity. For example, when a customer support agent has not responded to a question from a customer's employee for 4 hours, either of the machine-learning models 228 and/or 232 can decrease the customer's corresponding sentiment score. When a query occurs, the modeling frameworks 226 and/or 230 can internally derive the necessary factors from the customer support ticket's history and/or subsequent changes to the customer support ticket, and then determine the customer's sentiment.

Natural language processing can be a subfield of linguistics, computer science, and artificial intelligence concerned with the interactions between human communications and computers, particularly how to program computers to process and analyze large amounts of human communication data. A machine learning technique can be the use and development of computer systems that are able to acquire knowledge and adapt without following explicit instructions, by using algorithms and statistical models to analyze and draw inferences from patterns in data. An inference can be a conclusion reached on the basis of evidence and reasoning. A signal can be an indicator that is used to convey information. A conversational log can be a record of a discussion between people.

A support ticket can be a request logged onto a work tracking system detailing an issue that needs to be addressed. A customer can be a person or an organization that utilizes an item that was sold or leased. An event can be an occurrence or a thing that happens. A specified frequency can be a clearly identified rate at which something occurs or is repeated over a particular period of time or in a given sample.

The factors optionally include a rate of a complex status corresponding to the support tickets, a rate of an escalation status corresponding to the support tickets, an average resolution time corresponding to the support tickets, and/or a total count of the support tickets. For example, the modeling framework 230 derives factors indicating a decrease in the rate of Acme's support tickets that have a complex status and a decrease in the rate of Acme's support tickets that have an escalation status, including the most recent support ticket which is neither complex nor escalated. The modeling framework 230 can also derive factors indicating that during the most recent 90-day period, support agents are taking less time on average to close out Acme's cases compared to how much time they spent closing out Acme's cases historically, and that Acme has a total of 50 support tickets that were either created, closed, or open during the last month, which is a significantly smaller than average total number of these types of support tickets for Acme during a one-month period.

Each of the factors can correspond to a value associated with a time in one of the support tickets and can also correspond to a change in values associated with a current time and a preceding time in the one of the support tickets. For example, the machine-learning model 232 computes an absolute count of 8 Acme support tickets that have been escalated, and a trend which is a decrease by 7.5% in the rate of escalated Acme support tickets based on the previous rate of 10% escalated support tickets (10 of the 100 Acme support tickets had been escalated) and the current rate of 2.5% escalated support tickets (2 of the 80 Acme support tickets have been escalated).

In many situations, if a third party, such as a person who represents an original equipment manufacturer, is participating in support ticket interactions, then simply evaluating the support ticket interactions as a two-way conversation between a support agent and a customer is overly simplistic. Instead, the machine-learning models 228 and/or 232 need to differentiate a third-party communication, such as a comment by a representative for the original equipment manufacturer, from communications by a customer's employee and a customer support agent. Typically, customer relationship management systems record (and visually depict) customer support ticket comments as either from a customer support agent or from a customer's employee, even though some of those ‘customer’ comments could be from a third-party, such as a representative for the original equipment manufacturer. By analyzing the email address or email signature of comments that are not from a customer support agent, the machine-learning models 228 and/or 232 can disambiguate the customer communications and the third-party communications.

Additionally, there are several situations in which a customer support agent, a customer's employee, or a third party may reply with an automated response. It is helpful to identify such a situation so that the machine-learning models 228 and/or 232 do not evaluate such an automated response as part of the back-and-forth conversation between a customer's employee and a customer support agent. Likewise, the machine-learning models 228 and/or 232 can use a dedicated machine learning classifier to identify log messages and various categories of machine text on the basis of statistical differences between human text and machine text, so that the machine-learning models 228 and/or 232 do not evaluate such machine text as part of the back-and-forth conversation between a customer's employee and a customer support agent.

Furthermore, the machine-learning models 228 and/or 232 can identify and differentiate between customer's sentiment associated with their support experience and their product (or service) experience. Using conventional language-based sentiment models may be difficult in this context because of the highly asymmetric nature of the customer's sentiment towards the product and the support received for the use of the product, often simultaneously. The machine-learning models 228 and/or 232 can overcome such a challenge by using prior knowledge of both support environment-specific language and product-specific language and developing a software system designed to specifically detect each type independently, by using entity detection to determine if a customer's employee is discussing a product or service or the support for using the product or the service, and attribute the sentiment accordingly. Exemplary natural language processing may use dependency parsing to determine related language within sentences containing sentiments in order to determine the subject of the expressed customer sentiment. For example, if an expressed sentiment is determined to describe a known customer product using linguistic features, the sentiment will be associated with that product as opposed to the support for the use of that product.

Other certain types of features may clearly be identified using predetermined categories as being related to the support experience, and not a product, service, or support agent. These predetermined categories may include the words of phrases such as “helpful” or “not helpful,” “problem solved,” “problem not solved,” “ongoing issue,” “lack of progress,” (such that the customer is unhappy with the progress of the ticket thus far), “customer waiting,” “good information,” and “fast response.” It should be noted that while this method separates product sentiment from support sentiment, once this product information has been identified and separated, there are typically product organizations within a business that could readily leverage this information to better understand both the successes and shortcomings of the company's products. Consequently, the machine-learning models 228 and/or 232 can differentiate between the different customer sentiments expressed by the somewhat similar statements, “Your product has been great so far, but support has been very disappointing,” and “Your support has been great, but the product has been very disappointing.”

The machine-learning models 228 and/or 232 can also, in determining a customer sentiment score, utilize known regional and cultural differences when determining the strength of the sentiments. For example, a slightly negative sentiment from a British or Japanese customer may indicate a much greater level of displeasure than a similar statement from an American or Australian customer due to the British or Japanese cultures' relative level of general expressiveness. This differentiation can be achieved using available contextual information, such as where an agent or customer is located.

Having derived the factors for determining a customer's customer health score, the trained machine-learning model uses the factors to determine the customer health score associated with the customer, block 308. The system uses a trained machine-learning model and factors to determine a customer's health score. For example, and without limitation, this can include the trained production machine-learning model 232 using the derived factors to calculate Acme's newest customer health score of 80, which includes a customer sentiment sub-score of 95 for Ann's support ticket that Bob helped to quickly close.

Once a customer health score has been determined for a customer, there are many uses for this customer health score within the client's company, both inside and out of the support organization. The customer health score may be combined with data from other client company sources in order to maximize business value. For example, if the customer health score is combined with a sales system of record that tracks account managers and responsible salespersons, those individuals may be notified in real time of notable changes in their customers' sentiments.

Positive changes may indicate periods of sales opportunities, whereas negative changes may require discounts or proactive relationship management in order to maintain a productive business relationship. These consequences of the scores may be conveyed in the other direction back into the support organization so that support leadership could be informed to keep a close eye on cases from high-value customers. When such customers critical cases with customer sentiment scores that deviate from the norm, the support organization can ensure that the customer health score and the customer sentiment score of customers in a contract renewal period are closely monitored.

Since the customer's health score has been determined, a selection of escalating any customer account, de-escalating any customer account, escalating any support ticket, and/or de-escalating any support ticket, associated with the customer, is enabled in response to outputting the customer health score, block 310. The system outputs the customer health score, and possibly a customer sentiment score and customer sentiment sub-scores. By way of example and without limitation, this can include the production server 216 outputting the customer health score of 80 for Acme, which is partially based on the customer sentiment sub-score of 95 for Ann's support ticket that Bob helped to quickly close. Sue, who is one of the client's customer support supervisors, responds to these scores by de-escalating the customer account for Acme, thereby conserving some of the resources that would have been spent on supporting the support tickets for Acme during the next month.

The production modeling framework 230 stores the results of the production machine-learning model 232, which may be queried via REST endpoints or made accessible via a user interface. This enables the production modeling framework 230 to provide a list of any associated factors, ranked by importance, which explains why the production machine-learning model 232 generated a specific customer health score, a specific customer sentiment score, and/or any specific customer sentiment sub-scores. The production modeling framework 230 can generate this list of relevant factors using a process that analyzes localized calculations for perturbations around the input datapoint and computes model-agnostic explanations for the prediction.

The production server 216 may depict any instances of the customer health score, the customer sentiment score, and/or sub-scores of the customer sentiment score which satisfied corresponding minimum or maximum thresholds, via a user's graphic interface, either collectively or separately, to maximize the utility of the scoring. For example, depicting any customer sentiment sub-scores which are less than corresponding minimum thresholds or are more than corresponding maximum thresholds, alongside the customer sentiment score and the customer health score, may enable support agents, supervisors, and managers to build an understanding of a customer health score's context quickly so that the client's employees can act on that information in the most efficient means possible with or without a full understanding of all the technical content required to determine any of these scores. Each of these thresholds may be associated with at least one of a service contract renewal risk, a service contract renewal date, and/or one of escalating or de-escalating an account, related to the customer.

The production server 216 may base a threshold on a service contract renewal date associated with a customer. For example, if the customer health score is above the average customer health score of 70 for a sufficient period of time to establish the customer as a service renewal candidate, and the scheduled service subscription renewal date is within a month, then the production server 216 temporarily raises the customer sentiment sub-score's minimum threshold from 60 to 70 for any of the customer's support tickets that are critical or complex. A customer who has been identified as a service subscription renewal candidate by having a customer health score above a 70 within a month of the scheduled service subscription renewal date should receive special attention for their critical and complex support tickets that have a customer sentiment score below 70, because deals may be lost if a customer's impression of a product or a service organization is negatively impacted at critical times, such as shortly before the customer's service renewal date. Providing “white glove” treatment for a customer approaching a service renewal date improves the likeliness of the customer renewing their service contract. A service contract renewal date can be a time to decide to extend an agreement to support a customer.

The production server 216 may base a threshold on a service contract renewal risk associated with a customer. For example, if a customer health score is below the average customer health score of 70 for a sufficient period of time to establish a customer as a churn risk, the production server 216 temporarily raises the customer sentiment sub-score's minimum threshold from 60 to 70 for only the customer's support tickets that are critical. The customer who has been flagged as a potential churn risk by a customer health score below 70 for a sufficient period of time should receive special attention only for their critical support tickets that have a customer sentiment score below 70, because it is believed that the customer's account may be saved by allocating extra support to these critical support tickets. Conversely, if a customer has decided not to renew their service contract, reducing escalations by the customer is likely to be of lower importance and benefit. Additionally, for customers who have been flagged as a significant churn risk by a customer health score below 60 for a significant period of time may not receive special attention for their support tickets that have a customer sentiment score below 60, because it is believed that the customer's account may not be capable of being saved by allocating any extra support to any of the customer's support tickets. A service contract renewal risk can be a possibility of a customer not extending an agreement to support the customer.

The production server 216 may base a threshold on increasing a likelihood of continued business with that customer who received a historically poor quality of support. For example, if the customer sentiment score for customer support has repeatedly been below a 70 for a sufficient period of time to establish a customer as a poorly supported customer, yet the customer has maintained at least the average customer health score of 70 despite the negative support experiences, the production server 216 temporarily raises the customer sentiment sub-score's minimum threshold from 60 to 70 for all of the customer's support tickets. Customers may forgive the occasional poor experience with a support agent, but if poor support becomes the norm, the customer experience may soon reach a point of negativity whereby that customer may be willing to terminate a business relationship, despite the customer's currently above-average customer health score. Examining a customer's recent experiences with support agents and providing early/proactive intervention for customers that have experienced poor support is critical to improving the customer relationship and increasing the likelihood of continued business with that customer.

The production server 216 may base a threshold on escalating or de-escalating a customer account in response to a critical impact of a problem of a support ticket associated with a customer. For example, if the customer health score is above 75 for a sufficient period of time to establish a customer as a healthy and well-supported customer, the production server 216 becomes less sensitive to allocating additional support to the customer's support tickets by lowering the threshold from a 70 to a 60 for a customer's support ticket based on the critical impact of the support ticket's problem. The critical impact associated with different types of support ticket problems can range by various levels of severity or from significant to insignificant. Support tickets which are producing a more severe disruption to the customer are obviously more important to prevent from escalating, but after additional support has been provided for enough time, the production server 216 can return a healthy customer to a normal level of support.

An impact can be the effect of one thing on another thing. A problem can be an issue that needs to be dealt with and overcome.

When a specific score satisfies a specific threshold, the production server 216 can output an alert to the support agent responsible for the support ticket and the customer, or to the support agent's supervisor, and/or output the support ticket to the user interface of the support agent and/or the supervisor. Further, when a specific score satisfies a specific threshold, the production server 216 can provide alerts to additional teams, such as sales and product development teams. Since the thresholds can differ by customer, product type, size of customer account, proximity to contract renewal, customer sentiment, potential churn risk, quality of support provided, escalations of support, support tickets initiated, and impacts of problems, etc., these thresholds do not need to be the same for all customers across all support tickets. An alert can be a warning.

The system 200 can continuously recompute the customer health score, the customer sentiment score, and the customer sentiment sub-scores as the support tickets evolve, thereby providing a customer support company with a continuous view of a customer support ticket's status as time progresses. When deployed into production, the production server 216 can display the customer health score, the customer sentiment score, and the customer sentiment sub-scores being generated to the support agents who are managing the case queues. As discussed above, these customer health scores, customer sentiment scores, and customer sentiment sub-scores may be accompanied by an explanation of the corresponding score, such as the factors that are driving the score generation, which makes the scores significantly more actionable. For example, when a support agent is presented with a customer health score, a customer sentiment score, and a customer sentiment sub-score which indicates that one of the current support tickets is at risk of escalation, the customer support agent can review the factors driving a customer sentiment sub-score for a customer support ticket, review the customer support ticket which is at risk for escalation, and then take action and intervene in the support ticket (either directly or indirectly), or decide that no action is necessitated.

The production modeling framework 230 is also flexible in that it enables clients to ingest not only support ticket data, but also data from other disparate sources (such as Net Promoter Score and Customer Satisfaction Score), all with the end-goal of obtaining the most accurate and reliable representation of customer health at any point in time. Currently, the customer health score is an indicator of customer support health since it primarily ingests signals from support tickets. However, since the production modeling framework 230 is capable of ingesting data from other sources, the generated customer health score may be provided specific types of data to specifically target individual objectives selected from minimizing customer account escalation and churn risk and maximizing the rate of renewal and the probability of upsell. In summary, the customer health score is a comprehensive and robust metric that takes the whole customer journey into consideration when assessing the health of a customer. Unlike existing metrics such as Net Promoter Score (NPS) and Customer Satisfaction Score (CSAT) that are too subjective and do not really measure actual customer loyalty with any reasonable accuracy, the approach taken to assess customer health is more data driven while also being flexible because it is not restricted to a single source of data, such as surveys.

The customer health and the customer sentiment assessment procedures described above may be performed automatically and in near-real-time through automated analysis of business interactions with customers, potentially through an integration of the client's customer support ticket application 222 with the customer's Customer Relationship Management (CRM) application 220. In addition to the above-described features, users who have the appropriate administrator privileges can manually provide feedback and override the customer health score and the customer sentiment score generated by the machine-learning models 228 and/or 232. This feedback not only immediately influences the customer health score and the customer sentiment score, but can be leveraged to iteratively improve the accuracy of the machine-learning models 228 and/or 232, ensuring that the accuracy of the customer health score and the customer sentiment score improves as time progresses. The customer health and the customer sentiment scoring system is dynamic and can be recomputed from the raw data source, allowing the system to get better and increasingly sophisticated with time.

After determining and outputting customer health scores, data which includes the support tickets, the factors, and the customer health score, is optionally used to retrain the machine-learning model to determine a subsequent customer health score associated with a subsequent customer corresponding to subsequent support tickets, block 312. The system retrains the machine-learning model as needed. In embodiments, this can include the training modeling framework 226 using data which includes the support tickets, the factors, and the customer health score which were derived and determined for multiple customers, including Acme Corporation, to retrain the training machine-learning model 228 to determine an Acme's improved accuracy customer health score corresponding to Acme's newest set of support tickets. Data can be information.

Although FIG. 3 depicts the blocks 302-312 occurring in a specific order, the blocks 302-312 can occur in another order. In other implementations, each of the blocks 302-312 can also be executed in combination with other blocks and/or some blocks may be divided into a different set of blocks.

In exemplary hardware device in which the subject matter may be implemented shall be described. Those of ordinary skill in the art will appreciate that the elements illustrated in FIG. 4 can vary depending on the system implementation. With reference to FIG. 4, an exemplary system for implementing the subject matter disclosed herein includes a hardware device 400, including a processing unit 402, a memory 404, a storage 406, a data entry module 408, a display adapter 410, a communication interface 412, and a bus 414 that couples elements 404-412 to the processing unit 402.

The bus 414 can comprise any type of bus architecture. Examples include a memory bus, a peripheral bus, a local bus, etc. The processing unit 402 is an instruction execution machine, apparatus, or device and can comprise a microprocessor, a digital signal processor, a graphics processing unit, an application specific integrated circuit (ASIC), a field programmable gate array (FPGA), etc. The processing unit 402 may be configured to execute program instructions stored in the memory 404 and/or the storage 406 and/or received via the data entry module 408.

The memory 404 can include a read only memory (ROM) 416 and a random-access memory (RAM) 418. The memory 404 may be configured to store program instructions and data during operation of the hardware device 400. In various embodiments, the memory 404 can include any of a variety of memory technologies such as static random-access memory (SRAM) or dynamic RAM (DRAM), including variants such as dual data rate synchronous DRAM (DDR SDRAM), error correcting code synchronous DRAM (ECC SDRAM), or RAMBUS DRAM (RDRAM), for example.

The memory 404 can also include nonvolatile memory technologies such as nonvolatile flash RAM (NVRAM) or ROM. In some embodiments, it is contemplated that the memory 404 can include a combination of technologies such as the foregoing, as well as other technologies not specifically mentioned. When the subject matter is implemented in a computer system, a basic input/output system (BIOS) 420, containing the basic routines that help to transfer information between elements within the computer system, such as during start-up, is stored in the ROM 416.

The storage 406 can include a flash memory data storage device for reading from and writing to flash memory, a hard disk drive for reading from and writing to a hard disk, a magnetic disk drive for reading from or writing to a removable magnetic disk, and/or an optical disk drive for reading from or writing to a removable optical disk such as a CD ROM, DVD or other optical media. The drives and their associated computer-readable media provide nonvolatile storage of computer readable instructions, data structures, program modules and other data for the hardware device 400.

It is noted that the methods described herein may be embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media may be used which can store data that is accessible by a computer, such as magnetic cassettes, flash memory cards, digital video disks, Bernoulli cartridges, RAM, ROM, and the like can also be used in the exemplary operating environment. As used here, a “computer-readable medium” can include one or more of any suitable media for storing the executable instructions of a computer program in one or more of an electronic, magnetic, optical, and electromagnetic format, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high-definition DVD (HD-DVD™), a BLU-RAY disc; and the like.

A number of program modules may be stored on the storage 406, the ROM 416 or the RAM 418, including an operating system 422, one or more applications programs 424, program data 426, and other program modules 428. A user can enter commands and information into the hardware device 400 through data entry module 408. The data entry module 408 can include mechanisms such as a keyboard, a touch screen, a pointing device, etc.

Other external input devices (not shown) are connected to the hardware device 400 via an external data entry interface 410. By way of example and not limitation, external input devices can include a microphone, joystick, game pad, satellite dish, scanner, or the like. In some embodiments, external input devices can include video or audio input devices such as a video camera, a still camera, etc. The data entry module 408 may be configured to receive input from one or more users of the hardware device 400 and to deliver such input to the processing unit 402 and/or the memory 404 via the bus 414.

A display 412 is also connected to the bus 414 via the display adapter 410. The display 412 may be configured to display output of the hardware device 400 to one or more users. In some embodiments, a given device such as a touch screen, for example, can function as both the data entry module 408 and the display 412. External display devices can also be connected to the bus 414 via the external display interface 434. Other peripheral output devices, not shown, such as speakers and printers, may be connected to the hardware device 400.

The hardware device 400 can operate in a networked environment using logical connections to one or more remote nodes (not shown) via the communication interface 412. The remote node may be another computer, a server, a router, a peer device or other common network node, and typically includes many or all of the elements described above relative to the hardware device 400. The communication interface 412 can interface with a wireless network and/or a wired network. Examples of wireless networks include, for example, a BLUETOOTH network, a wireless personal area network, a wireless 802.21 local area network (LAN), and/or wireless telephony network (e.g., a cellular, PCS, or GSM network).

Examples of wired networks include, for example, a LAN, a fiber optic network, a wired personal area network, a telephony network, and/or a wide area network (WAN). Such networking environments are commonplace in intranets, the Internet, offices, enterprise-wide computer networks and the like. In some embodiments, the communication interface 412 can include logic configured to support direct memory access (DMA) transfers between the memory 404 and other devices.

In a networked environment, program modules depicted relative to the hardware device 400, or portions thereof, may be stored in a remote storage device, such as, for example, on a server. It will be appreciated that other hardware and/or software to establish a communications link between the hardware device 400 and other devices may be used.

It should be understood that the arrangement of the hardware device 400 illustrated in FIG. 4 is but one possible implementation and that other arrangements are possible. It should also be understood that the various system components (and means) defined by the claims, described below, and illustrated in the various block diagrams represent logical components that are configured to perform the functionality described herein. For example, one or more of these system components (and means) may be realized, in whole or in part, by at least some of the components illustrated in the arrangement of the hardware device 400.

In addition, while at least one of these components are implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function), such as those illustrated in FIG. 4.

Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the descriptions above, the subject matter is described with reference to acts and symbolic representations of operations that are performed by one or more devices, unless indicated otherwise. As such, it is understood that such acts and operations, which are at times referred to as being computer-executed, include the manipulation by the processing unit of data in a structured form. This manipulation transforms the data or maintains it at locations in the memory system of the computer, which reconfigures or otherwise alters the operation of the device in a manner well understood by those skilled in the art. The data structures where data is maintained are physical locations of the memory that have particular properties defined by the format of the data. However, while the subject matter is described in a context, it is not meant to be limiting as those of skill in the art will appreciate that various of the acts and operations described hereinafter can also be implemented in hardware.

To facilitate an understanding of the subject matter described above, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A system for determining customer health scores, the system comprising:
one or more processors; and
a non-transitory computer readable medium storing a plurality of instructions, which when executed, cause the one or more processors to:
derive training set factors for a customer sentiment score associated with a training set customer corresponding to a plurality of training set support tickets, and a training set factor for a rate of a critical status corresponding to the plurality of training set support tickets;
train, using the training set factors, a machine-learning model to determine a customer health score associated with the training set customer;
derive factors for a customer sentiment score associated with a customer corresponding to a plurality of support tickets, and a factor for a rate of a critical status corresponding to the plurality of support tickets;
determine, by the trained machine-learning model using the factors, a customer health score associated with the customer; and
enable a selection of at least one of escalating any customer account, de-escalating any customer account, escalating any support ticket, or de-escalating any support ticket, associated with the customer, in response to outputting the customer health score.

2. The system of claim 1, wherein deriving any factors for the customer sentiment score comprises using natural language processing and machine learning techniques to extract, analyze, and draw inferences from signals from conversational logs in support tickets corresponding to the customer when an event occurs for any of the corresponding support tickets and at a specified frequency for any of the corresponding support tickets.

3. The system of claim 1, wherein the plurality of instructions further causes the processor to retrain, using data which includes the plurality of support tickets, the factors, and the customer health score, the machine-learning model to determine a subsequent customer health score associated with a subsequent customer corresponding to a subsequent plurality of support tickets.

4. The system of claim 1, wherein the training set factors further comprise at least one of a rate of a complex status corresponding to the plurality of training set support tickets or a rate of an escalation status corresponding to the plurality of training set support tickets, and the factors further comprise at least one of a rate of a complex status corresponding to the plurality of support tickets or a rate of an escalation status corresponding to the plurality of support tickets.

5. The system of claim 1, wherein the training set factors further comprise at least one of an average resolution time corresponding to the plurality of training set support tickets or a total count of the plurality of training set support tickets, and the factors further comprise at least one of an average resolution time corresponding to the plurality of support tickets or a total count of the plurality of support tickets.

6. The system of claim 1, wherein each of the training set factors correspond to a value associated with a time in one of the plurality of training set support tickets and correspond to a change in values associated with a current time and a preceding time in the one of the plurality of training set support tickets, and each of the factors correspond to a value associated with a time in one of the plurality of support tickets and correspond to a change in values associated with a current time and a preceding time in the one of the plurality of support tickets.

7. The system of claim 1, wherein outputting the customer health score comprises outputting at least one of the customer sentiment score or a sub-score of the customer sentiment score in response to a determination that one of the customer health score, the customer sentiment score, or the sub-score of the customer sentiment score satisfies one of a minimum threshold or a maximum threshold, which is associated with at least one of a service contract renewal risk, a service contract renewal date, or one of escalating or de-escalating an account, related to the customer.

8. A computer-implemented method for determining customer health scores, the computer-implemented method comprising:
deriving training set factors for a customer sentiment score associated with a training set customer corresponding to a plurality of training set support tickets, and a training set factor for a rate of a critical status corresponding to the plurality of training set support tickets;
training, using the training set factors, a machine-learning model to determine a customer health score associated with the training set customer;
deriving factors for a customer sentiment score associated with a customer corresponding to a plurality of support tickets, and a factor for a rate of a critical status corresponding to the plurality of support tickets;
determining, by the trained machine-learning model using the factors, a customer health score associated with the customer; and
enabling a selection of at least one of escalating any customer account, de-escalating any customer account, escalating any support ticket, or de-escalating any support ticket, associated with the customer, in response to outputting the customer health score.

9. The computer-implemented method of claim 8, wherein deriving any factors for the customer sentiment score comprises using natural language processing and machine learning techniques to extract, analyze, and draw inferences from signals from conversational logs in support tickets corresponding to the customer when an event occurs for any of the corresponding support tickets and at a specified frequency for any of the corresponding support tickets.

10. The computer-implemented method of claim 8, wherein the computer-implemented method further comprises retraining, using data which includes the plurality of support tickets, the factors, and the customer health score, the machine-learning model to determine a subsequent customer health score associated with a subsequent customer associated with a subsequent plurality of support tickets.

11. The computer-implemented method of claim 8, wherein the training set factors further comprise at least one of a rate of a complex status corresponding to the plurality of training set support tickets or a rate of an escalation status corresponding to the plurality of training set support tickets, and the factors further comprise at least one of a rate of a complex status corresponding to the plurality of support tickets or a rate of an escalation status corresponding to the plurality of support tickets.

12. The computer-implemented method of claim 8, wherein the training set factors further comprise at least one of an average resolution time corresponding to the plurality of training set support tickets or a total count of the plurality of training set support tickets, and the factors further comprise at least one of an average resolution time corresponding to the plurality of support tickets or a total count of the plurality of support tickets.

13. The computer-implemented method of claim 8, wherein each of the training set factors correspond to a value associated with a time in one of the plurality of training set support tickets and correspond to a change in values associated with a current time and a preceding time in the one of the plurality of training set support tickets, and each of the factors correspond to a value associated with a time in one of the plurality of support tickets and correspond to a change in values associated with a current time and a preceding time in the one of the plurality of support tickets.

14. The computer-implemented method of claim 8, wherein outputting the customer health score comprises outputting at least one of the customer sentiment score or a sub-score of the customer sentiment score in response to a determination that one of the customer health score, the customer sentiment score, or the sub-score of the customer sentiment score satisfies one of a minimum threshold or a maximum threshold, which is associated with at least one of a service contract renewal risk, a service contract renewal date, or one of escalating or de-escalating an account, related to the customer.

15. A computer program product, comprising a non-transitory computer-readable medium having a computer-readable program code embodied therein to be executed by one or more processors, the program code including instructions to:
derive training set factors for a customer sentiment score associated with a training set customer, associated with a plurality of training set support tickets, and a training set factor for a rate of a critical status corresponding to the plurality of training set support tickets;
train, using the training set factors, a machine-learning model to determine a customer health score associated with the training set customer;
derive factors for a customer sentiment score associated with a customer corresponding to a plurality of support tickets, and a factor for a rate of a critical status corresponding to the plurality of support tickets;
determine, by the trained machine-learning model using the factors, a customer health score associated with the customer; and
enable a selection of at least one of escalating any customer account, de-escalating any customer account, escalating any support ticket, or de-escalating any support ticket, associated with the customer, in response to outputting the customer health score.

16. The computer program product of claim 15, wherein deriving any factors for the customer sentiment score comprises using natural language processing and machine learning techniques to extract, analyze, and draw inferences from signals from conversational logs in support tickets corresponding to the customer when an event occurs for any of the corresponding support tickets and at a specified frequency for any of the corresponding support tickets.

17. The computer program product of claim 15, wherein the program code includes further instructions to retrain, using data which includes the plurality of support tickets, the factors, and the customer health score, the machine-learning model to determine a subsequent customer health score associated with a subsequent customer associated with a subsequent plurality of support tickets.

18. The computer program product of claim 15, wherein the training set factors further comprise at least one of a rate of a complex status corresponding to the plurality of training set support tickets, a rate of an escalation status corresponding to the plurality of training set support tickets, an average resolution time corresponding to the plurality of training set support tickets, or a total count of the plurality of training set support tickets, and the factors further comprise at least one of a rate of a complex status corresponding to the plurality of support tickets, a rate of an escalation status corresponding to the plurality of support tickets, an average resolution time corresponding to the plurality of support tickets, or a total count of the plurality of support tickets.

19. The computer program product of claim 15, wherein each of the training set factors correspond to a value associated with a time in one of the plurality of training set support tickets and correspond to a change in values associated with a current time and a preceding time in the one of the plurality of training set support tickets, and each of the factors correspond to a value associated with a time in one of the plurality of support tickets and correspond to a change in values associated with a current time and a preceding time in the one of the plurality of support tickets.

20. The computer program product of claim 15, wherein outputting the customer health score comprises outputting at least one of the customer sentiment score or a sub-score of the customer sentiment score in response to a determination that one of the customer health score, the customer sentiment score, or the sub-score of the customer sentiment score satisfies one of a minimum threshold or a maximum threshold, which is associated with at least one of a service contract renewal risk, a service contract renewal date, or one of escalating or de-escalating an account, related to the customer.
